(19) United States
(12) Patent Application Publication
(10) Pub. No.: US 2007/0216620 A1
(43) Pub. Date: Sep. 20, 2007

(54) Charge pump circuit, LCD driver IC, and liquid crystal display device

(76) Inventors: Takashi Nagai, Kyoto-shi (JP); Akito Ito, Otsu-shi (JP)

Correspondence Address: FISH & RICHARDSON P.C., P.O. BOX 1022, MINNEAPOLIS, MN, 55440-1022, US

(21) Appl. No.: 11/725,626

(22) Filed: Mar. 19, 2007

(30) Foreign Application Priority Data
Mar. 20, 2006 (JP) 2006-077148

(51) Int. Cl. G09G 3/36

(52) U.S. Cl. 345/87

(57) ABSTRACT

A charge pump circuit has a first controller (in the embodiments, switches SW1a to SW4b and charge transfer transistors P2b to P4b) that increases and decreases the number of step-up units actually operated according to the specified step-up factor; and a second controller (in the embodiments, an inverter INV4) varies the step-up input voltage in one of the step-up units according to the specified step-up factor. With this configuration, it is possible to vary the step-up factor finely and in a wide range without unnecessarily increasing the number of step-up stages.

This application is based on Japanese Patent Application No. 2006-077148 filed on Mar. 20, 2006, the contents of which are hereby incorporated by reference.

### BACKGROUND OF THE INVENTION

1. Field of the Invention

The present invention relates to charge pump circuits that step up an input voltage to produce a desired output voltage, and to LCD driver ICs and liquid crystal display devices incorporating such charge pump circuits.

2. Description of Related Art

Conventionally, charge pump circuits are known that produce a desired output voltage by positively or negatively stepping up an input voltage through a plurality of stages of step-up units built with charge transfer transistors and charge transfer capacitors.

Some conventionally known charge pump circuits are capable of changing their step-up factor by increasing or decreasing the number of stages of step-up units actually operated.

As an example of a conventional technology related to the present invention, JP-A-H9-198887 (hereinafter “Patent Document 1”) discloses and proposes a high voltage generation circuit so configured as to select, on an alternative basis, whether to use, as an output terminal, a highest-potential node to output a positive high voltage or a lowest-potential node to output a negative high voltage.

Certainly, with the conventional charge pump circuits described above, it is possible to produce a desired output voltage by changing the number of stages of step-up units actually operated (and hence the step-up factor) to cope with varying load condition or input voltage.

In the conventional charge pump circuits described above, the step-up unit in each stage receives an equal step-up input voltage (i.e., the pulse voltage applied to that end of the charge transfer capacitor that is not connected to the charge transfer transistor has an equal amplitude). Thus, a disadvantage with the conventional charge pump circuits is that their step-up factor can be selected only among values that form an arithmetic progression with a common difference equal to the just mentioned step-up input voltage (e.g., among factors of 2, 4, 6, 8, and so forth).

In TFD (thin-film diode) liquid crystal display panels (hereinafter “LCD panels), which employ thin-film diodes as active elements for turning liquid crystal cells ON and OFF, since the optimal drive voltage of the thin-film diodes varies with the ambient temperature, their actual drive voltage needs to be compensated optimally according to temperature. For that purpose, charge pump circuits used to produce a drive voltage in TFD LCD panels are required to be capable of changing their output voltage finely and in a wide range. This requirement, however, is not met by the conventional charge pump circuits described above.

To be sure, even with the conventional charge pump circuits described above, it is possible to change their step-up factor finely if the step-up input voltage is set low enough and they are so configured as to output voltages equal to the step-up input voltage multiplied by factors of 2, 3, 4, 5, and so forth. Simply setting the step-up input voltage low, however, necessitates an accordingly large number of step-up units (and hence an accordingly large number of externally fitted charge-transfer capacitors with which they are built). This leads to an unduly large circuit scale and an unduly high cost, making it impracticable to set the step-up input voltage low.

Incidentally, the conventional technology of Patent Document 1 simply allows choice, with a single circuit, between a positive high voltage and a negative high voltage on an alternative basis, and thus does not help solve the disadvantage mentioned above.

### SUMMARY OF THE INVENTION

An object of the present invention is to provide charge pump circuits that can change their step-up factor finely and in a wide range without requiring an unnecessarily large number of step-up stages, and to provide LCD driver ICs and liquid crystal display devices incorporating such charge pump circuits.

To achieve the above object, according to one aspect of the invention, a charge pump circuit includes: a plurality of stages of step-up units each comprising a charge transfer transistor and a charge transfer capacitor; a first controller increasing and decreasing the number of step-up units actually operated according to the specified step-up factor; and a second controller varying the step-up input voltage in at least one of the step-up units according to the specified step-up factor. Here, the charge pump circuit produces the desired output voltage by stepping up the input voltage with those stages of step-up units.

Other features, elements, steps, advantages and characteristics of the present invention will become more apparent from the following detailed description of preferred embodiments thereof with reference to the attached drawings.

### BRIEF DESCRIPTION OF THE DRAWINGS

FIG. 1 is a block diagram of a cellular phone terminal according to the invention;

FIG. 2 is a timing chart showing an example of scanning signals and data signals;

FIG. 3 is a circuit block diagram of a power supply circuit 31 according to a first embodiment of the invention;

FIG. 4 is a circuit block diagram showing an example of the configuration of an inverter INV4; and

FIG. 5 is a circuit block diagram of a power supply circuit 31 according to a second embodiment of the invention.

### DETAILED DESCRIPTION OF PREFERRED EMBODIMENTS

Hereinafter, the present invention will be described by way of an example in which it is applied to a power supply circuit (DC/DC converter) for a liquid crystal display device incorporated in a cellular phone terminal.

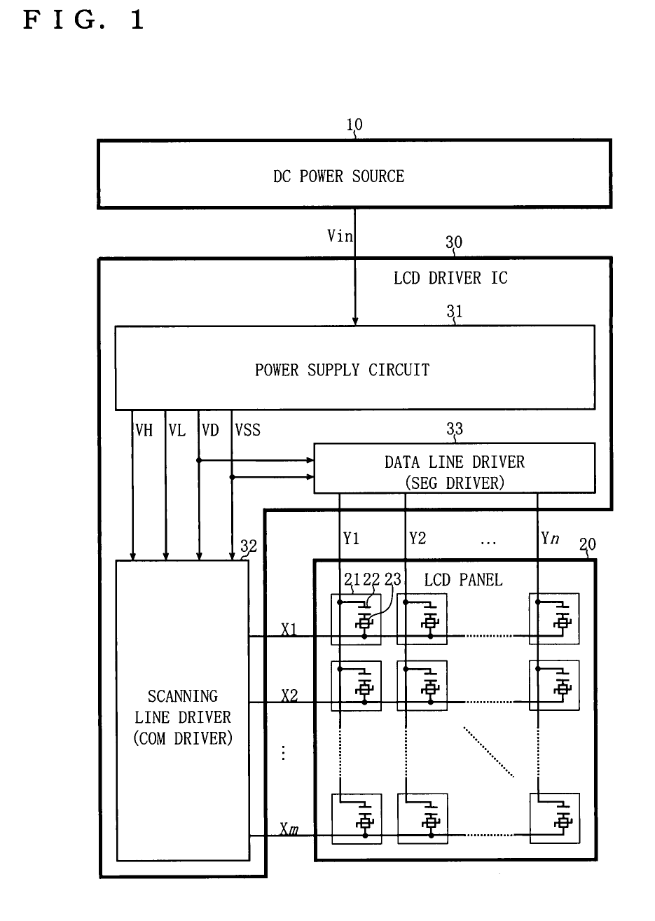

FIG. 1 is a block diagram showing a cellular phone terminal according to the invention. As shown in the figure, this cellular phone terminal includes a DC (direct-current) power source 10 that supplies electric power to the terminal, a liquid crystal display panel 20 (hereinafter “LCD panel 20”) on which the terminal displays information etc., and an LCD driver IC 30 that drives and controls the LCD panel 20. Needless to say, the cellular phone terminal further includes, although unillustrated, other functional blocks with which it achieves its essential capabilities (communication and other capabilities), such as a transmitter/receiver circuit, a loudspeaker, a microphone, a display, an operation panel, and a memory.

The DC power source 10 supplies electric power to different parts of the terminal; it may be a rechargeable battery such as a lithium-ion battery, or an AC/DC converter that produces a DC voltage from a commercially distributed AC (alternating-current) voltage.

The LCD panel 20 is of the TFD (thin-film diode) active-matrix type; specifically, it has a plurality of scanning lines X1 to Xm (where m is a prescribed natural number) laid in the horizontal direction, and has a plurality of data lines Y1 to Yn (where n is a prescribed natural number) laid in the vertical direction, with a liquid crystal cell 22 forming a pixel 21 located at each intersection between those scanning and data lines, the liquid crystal cell 22 being driven by a corresponding active element (in the example under discussion, a thin-film diode 23) being turned ON and OFF.

For the sake of simplicity, the example under discussion deals with a configuration where each pixel 21 contains one liquid crystal cell 22 and one thin-film diode 23 (i.e., a configuration for monochrome display). This, however, is not meant to limit the application of the invention in any way; the invention is applicable also to, for example, a configuration for color display with three colors, namely R, G, and B, in which case each pixel may contain three liquid crystal cells and three thin-film diodes corresponding to R, G, and B respectively.

The example under discussion deals with a configuration where, in each pixel 21, the liquid crystal cell 22 and the thin-film diode 23 are serially connected, with the liquid crystal cell 22 connected to the corresponding data line, one of Y1 to Yn, and the thin-film diode 23 connected to the corresponding scanning line, one of X1 to Xm. This, however, is not meant to limit the application of the invention in any way; the invention is applicable also to, for example, a configuration where the liquid crystal cell 22 and the thin-film diode 23 are connected the other way around.

The example under discussion deals with a TFD active-matrix LCD panel, which uses thin-film diodes as active elements. This, however, is not meant to limit the application of the invention in any way; the invention is applicable also to, for example, a TFT (thin-film transistor) active-matrix LCD panel, which uses thin-film transistors as active elements.

The LCD driver IC 30 includes a power supply circuit 31, a scanning line driver (common driver, or COM driver) 32, and a data line driver (segment driver, or SEG driver) 33.

The power supply circuit 31 operates from an input voltage Vin supplied from the DC power source 10. The power supply circuit 31 produces a reference voltage VSS and other internal voltages (VH, VL, and VD) from the input voltage Vin, and feeds them to different parts (such as the scanning line driver 32 and the data line driver 33) of the IC.

The internal voltages VH and VL vary with the ambient temperature (e.g., the internal voltage VH varies between +5 V and +22.5 V, and the internal voltage VL varies between −18.5 V and −1 V). By contrast, the internal voltage VD is produced from a band gap voltage, which does not depend on the ambient temperature, and is therefore constant (e.g., +4 V). The reference voltage VSS equals the ground voltage (0 V).

According to image signals and timing control signals (of which none is illustrated) fed in from outside the IC, the scanning line driver 32 and the data line driver 33 produce scanning signals and data signals with which to drive the LCD panel 20, and feed those signals via the scanning lines X1 to Xm and the data lines Y1 to Yn to the LCD panel 20.

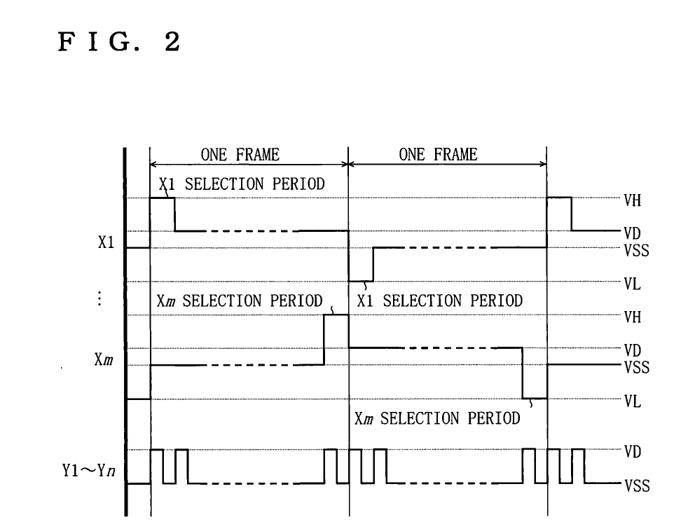

Here, the LCD panel 20 is driven in the following manner (by so-called four-level driving). The scanning signals fed via the scanning lines X1 to Xm to the LCD panel 20 are controlled as shown in FIG. 2. Specifically, within each frame period, the scanning lines X1 to Xm are selected one after the next, and one at a time, so that, during the period in which a given scanning line is selected (i.e., during its selection period), either a positive, first selection voltage (the internal voltage VH) or a negative, second non-selection voltage (the internal voltage VD), alternately between consecutive frames, is applied to that scanning line and, during the period in which a given scanning line is not selected (i.e., during its non-selection period), either a first non-selection voltage (the internal voltage VD) or a second non-selection voltage (the reference voltage VSS), alternately between consecutive, is applied to that scanning line. This manner of driving helps reduce degradation of image quality compared with one in which the polarity of the selection voltage applied in consecutive frame periods remains constant.

The data signals fed via the data lines Y1 to Yn to the LCD panel 20 are controlled as shown in FIG. 2. Specifically, with either the internal voltage VD or the reference voltage VSS applied to each data line at a time, the data signal on that signal line is a binary signal, and its ON duty within the selection period of a given scanning line is so controlled as to control the gray scale level of the corresponding pixel.

Thus, to produce the scanning signals, the scanning line driver 32 requires, in addition to the reference voltage VSS, the internal voltages (VH, VL, and VD) having three different levels; to produce the data signals, the data line driver 33 requires the reference voltage VSS and the internal voltage VD.

Accordingly, in the example under discussion, the power supply circuit 31 includes, to produce a negative voltage needed to produce the internal voltage VL, a negative step-up charge pump circuit that negatively steps up the input voltage Vin to produce a desired output voltage Vout.

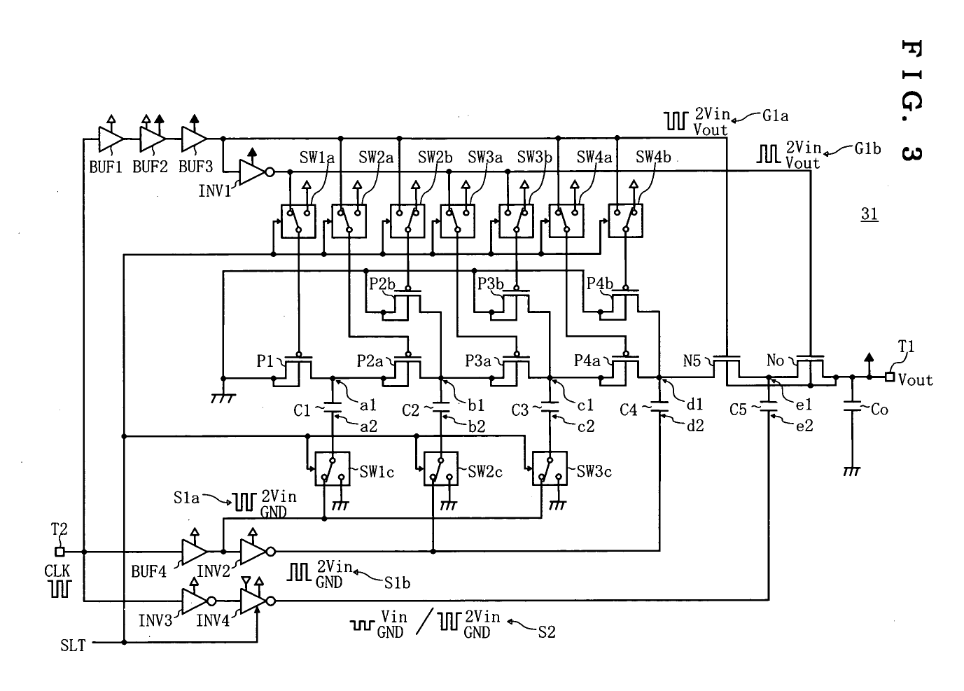

First, as a first embodiment of the invention, an example of the negative step-up charge pump circuit included in the power supply circuit 31 will be described in detail below, with reference to FIG. 3.

FIG. 3 is a circuit block diagram of the power supply circuit 31 (and in particular the negative step-up charge pump circuit included in it) according to the first embodiment.

As shown in FIG. 3, in this embodiment, the negative step-up charge pump circuit includes charge transfer transistors P1, P2a, P2b, P3a, P3b, P4a, P4b, and N5, an output transistor No, charge transfer capacitor C1 to C5, an output capacitor Co, buffers BUF1 to BUF4, inverters INV1 to INV4, and switches SW1a, SW1c, SW2a, SW2b, SW2c, SW3a, SW3b, SW3c, SW4a, and SW4b. In addition to this negative step-up charge pump circuit, the power supply circuit 31 of this embodiment further includes a positive step-up charge pump circuit (unillustrated) that produces from the input voltage Vin a positively stepped-up voltage 2Vin twice as high.

The charge transfer transistors P1, P2a, P3a, P4a, and N5 are serially connected in this order from ground. The output transistor No is connected between the charge transfer transistor N5 and an output voltage output terminal Ti.

The charge transfer transistor P2b is connected between ground and a node b1 (at which the charge transfer transistors P2a and P3a are connected together). The charge transfer transistor P3b is connected between ground and a node c1 (at which the charge transfer transistors P3a and P4a are connected together). The charge transfer transistor P4b is connected between ground and a node d1 (at which the charge transfer transistors P4a and N5 are connected together).

Of all the transistors mentioned above, the charge transfer transistors P1, P2a, P2b, P3a, P3b, P4a, and P4b are P-channel field-effect transistors, and the charge transfer transistor N5 and the output transistor No are N-channel field-effect transistors.

To simplify the fabrication process, the charge transfer transistor N5 and the output transistor No are formed by a process whereby a single well alone is formed on a P-type semiconductor substrate. Thus, the backgates of these transistors are connected to the lowest-potential point of the entire system, namely the output voltage output terminal T1. By contrast, the charge transfer transistors P1, P2a, P2b, P3a, P3b, P4a, and P4b have their backgates connected to their own sources respectively. This helps minimize the ON-state resistance of these transistors.

One end of the charge transfer capacitor C1 is connected to a node al (at which the charge transfer transistors P1 and P2a are connected together). Likewise, one ends of the charge transfer capacitors C2 to C5 are connected to the nodes b1 to d1 and a node e1 respectively. One end of the output capacitor Co is connected to the output voltage output terminal T1, and the other end of the output capacitor Co is grounded.

The buffers BUF1 to BUF3 and the inverter INV1 together serve to produce gate signals; specifically, they produce: a gate signal G1a, which is a pulse signal that changes its level between the stepped-up voltage 2Vin and the output voltage Vout in synchronism with a clock signal CLK fed in via a clock signal input terminal T2; and an inverted gate signal G1b, which is a logical inversion of the gate signal G1a. More specifically, the buffers BUF1 to BUF3 produce the gate signal G1a by shifting the amplitude level of the clock signal CLK to a desired amplitude level, and the inverter INV1 produces the inverted gate signal G1b by inverting the logic level of the gate signal G1a.

The buffer BUF4 and the inverter INV2 together serve to produce a first terminal voltage; specifically, they produce: a terminal voltage S1a, which is a pulse signal that changes its level between the stepped-up voltage 2Vin and the ground voltage GND in synchronism with the clock signal CLK; and an inverted terminal voltage S1b, which is a logical inversion of the terminal voltage S1a. More specifically, the buffer BUF4 produces the terminal voltage S1a by shifting the amplitude level of the clock signal CLK to a desired amplitude level, and the inverter INV2 produces the inverted terminal voltage S1b by inverting the logic level of the terminal voltage S1a.

The inverters INV3 to INV4 together serve to produce a second terminal voltage; specifically, they produce a variable terminal voltage S2, which is a pulse signal that changes its level either between the input voltage Vin and the ground voltage GND or between the stepped-up voltage 2Vin and the ground voltage GND in synchronism with the clock signal CLK. More specifically, the inverter INV3 generates an inverted clock signal CLKB by inverting the logic level of the clock signal CLK; the inverter INV4 generates the variable terminal voltage S2 by inverting back the logic level of the inverted clock signal CLKB and in addition shifting its amplitude level to a desired amplitude level according to a step-up factor switching signal SLT (i.e., according to the specified step-up factor).

Specifically, in this embodiment, when a step-up factor of 3, 5, 7, or 9 is specified, the variable terminal voltage S2 is a pulse signal that changes its level between the input voltage Vin and the ground voltage GND; when a step-up factor of 4, 6, 8, or 10 is specified, the variable terminal voltage S2 is a pulse signal that changes its level between the stepped-up voltage 2Vin and the ground voltage GND.

In FIG. 3, different marks put at the positive electrode of the buffers BUF1 to BUF4 and the inverters INV1 to INV4 have the following meanings: a hollow triangular mark (pointing up) indicates that the stepped-up voltage 2Vin is applied there; a hollow triangular mark (pointing down) indicates that the input voltage Vin is applied there; and a solid triangular mark indicates that the output voltage Vout is applied there.

The switch SW1a selectively feeds one of the inverted gate signal G1b and the stepped-up voltage 2Vin to the gate of the charge transfer transistor P1 according to the step-up factor switching signal SLT. Specifically, in this embodiment, when a step-up factor of 9 or 10 is specified, the switch SW1a is so switched that the inverted gate signal G1b is selectively fed to the gate of the charge transfer transistor P1. This permits the driving of the charge transfer transistor P1. When a step-up factor of 3, 4, 5, 6, 7, or 8 is specified, the switch SW1a is so switched that the stepped-up voltage 2Vin is selectively fed to the gate of the charge transfer transistor P1, this inhibits the driving of the charge transfer transistor P1.

The switches SW2a and SW2b each selectively feed one of the gate signal G1a and the stepped-up voltage 2Vin to the gates of the charge transfer transistors P2a and P2b respectively according to the step-up factor switching signal SLT. Specifically, in this embodiment, when a step-up factor of 9 or 10 is specified, the switches SW2a and SW2b are so switched that the gate signal G1a is selectively fed to the gate of the charge transfer transistor P2a, and that the stepped-up voltage 2Vin is selectively fed to the gate of the charge transfer transistor P2b. This permits the driving of the charge transfer transistor P2a, and inhibits the driving of the charge transfer transistor P2b. When a step-up factor of 7 or 8 is specified, SW2a and SW2b are so switched that the stepped-up voltage 2Vin is selectively fed to the gate of the charge transfer transistor P2a, and that the gate signal G1a is selectively fed to the gate of the charge transfer transistor P2b. This inhibits the driving of the charge transfer transistor P2a, and permits the driving of the charge transfer transistor P2b. When a step-up factor of 3, 4, 5, or 6 is specified, SW2a and SW2b are so switched that the stepped-up voltage 2Vin is selectively fed to the gates of both of the charge transfer transistors P2a and P2b. This inhibits the driving of both of the charge transfer transistors P2a and P2b.

The switches SW3a and SW3b each selectively feed one of the inverted gate signal G1b and the stepped-up voltage 2Vin to the gates of the charge transfer transistors P3a and P3b respectively according to the step-up factor switching signal SLT. Specifically, in this embodiment, when a step-up factor of 7, 8, 9, or 10 is specified, the switches SW3a and SW3b are so switched that the inverted gate signal G1b is selectively fed to the gate of the charge transfer transistor P3a, and that the stepped-up voltage 2Vin is selectively fed to the gate of the charge transfer transistor P3b. This permits the driving of the charge transfer transistor P3a, and inhibits the driving of the charge transfer transistor P3b. When a step-up factor of 5 or 6 is specified, the switches SW3a and SW3b are so switched that the stepped-up voltage 2Vin is selectively fed to the gate of the charge transfer transistor P3a, and that the inverted gate signal G1b is selectively fed to the gate of the charge transfer transistor P3b. This inhibits the driving of the charge transfer transistor P3a, and permits the driving of the charge transfer transistor P3b. When a step-up factor of 3 or 4 is specified, the switches SW3a and SW3b are so switched that the stepped-up voltage 2Vin is selectively fed to the gates of both of the charge transfer transistors P3a and P3b. This inhibits the driving of both of the charge transfer transistors P3a and P3b.

The switches SW4a and SW4b each selectively feed one of the gate signal G1a and the stepped-up voltage 2Vin to the gates of the charge transfer transistors P4a and P4b respectively according to the step-up factor switching signal SLT. Specifically, in this embodiment, when a step-up factor of 5, 6, 7, 8, 9, or 10 is specified, the switches SW4a and SW4b are so switched that the gate signal G1a is selectively fed to the gate of the charge transfer transistor P4a, and that the stepped-up voltage 2Vin is selectively fed to the gate of the charge transfer transistor P4b. This permits the driving of the charge transfer transistor P4a, and inhibits the driving of the charge transfer transistor P4b. When a step-up factor of 3 or 4 is specified, the switches SW4a and SW4b are so switched that the stepped-up voltage 2Vin is selectively fed to the gate of the charge transfer transistor P4a, and that the gate signal G1a is selectively fed to the gate of the charge transfer transistor P4b. This inhibits the driving of the charge transfer transistor P4a, and permits the driving of the charge transfer transistor P4b.

The gate signal G1a and the inverted gate signal G1b are fed directly to the gates of the charge transfer transistor N5 and the output transistor No respectively, without passing through any switch.

The switch SW1c selectively feeds one of the terminal voltage S1a and the ground voltage GND to the other end (a node a2) of the charge transfer capacitor C1 according to the step-up factor switching signal SLT. Specifically, in this embodiment, when a step-up factor of 9 or 10 is specified, the switch SW1c is so switched that the terminal voltage S1a is selectively fed to the other end (the node a2) of the charge transfer capacitor C1. When a step-up factor of 3, 4, 5, 6, 7, or 8 is specified, the switch SW1c is so switched that the ground voltage GND is selectively fed to the other end (the node a2) of the charge transfer capacitor C1.

The switch SW2c selectively feeds one of the inverted terminal voltage S1b and the ground voltage GND to the other end (a node b2) of the charge transfer capacitor C2 according to the step-up factor switching signal SLT. Specifically, in this embodiment, when a step-up factor of 7, 8, 9, or 10 is specified, the switch SW2c is so switched that the inverted terminal voltage S1b is selectively fed to the other end (the node b2) of the charge transfer capacitor C2. When a step-up factor of 3, 4, 5, or 6 is specified, the switch SW2c is so switched that the ground voltage GND is selectively fed to the other end (the node b2) of the charge transfer capacitor C2.

The switch SW3c selectively feeds one of the terminal voltage S1a and the ground voltage GND to the other end (a node c2) of the charge transfer capacitor C3 according to the step-up factor switching signal SLT. Specifically, in this embodiment, when a step-up factor of 5, 6, 7, 8, 9, or 10 is specified, the switch SW3c is so switched that the terminal voltage S1a is selectively fed to the other end (the node c2) of the charge transfer capacitor C3. When a step-up factor of 3 or 4 is specified, the switch SW3c is so switched that the ground voltage GND is selectively fed to the other end (the node c2) of the charge transfer capacitor C3.

As will be understood from the foregoing, the gate signal G1a and the inverted gate signal G1b are so fed that, of all the charge transfer transistors P1, P2a (P2b), P3a (P3b), P4a (P4b), and N5 and the output transistor No, every adjacent two are in opposite states in terms of whether they are ON or OFF. Moreover, the terminal voltage S1a, the inverted terminal voltage S1b, and the variable terminal voltage S2 are so fed that, of all the charge transfer capacitors C1 to C5, every adjacent two have different voltages at their respective other ends.

As described above, in this embodiment, the negative step-up charge pump circuit is configured as a charge pump circuit that negatively steps up an input voltage Vin to produce a desired output voltage Vout with a plurality of stages of step-up units built with charge transfer transistors and charge transfer capacitors, and includes a first controller (the switches SW1a to SW4b and the charge transfer transistors P2b to P4b) for increasing and decreasing the number of stages of step-up units actually operated according to the step-up factor specified and a second controller (the inverter INV4) for varying the step-up input voltage in one of the step-up units according to the step-up factor specified.

In the present specification, the step-up input voltage in a step-up unit denotes the amplitude of the pulse voltage applied to that end of the charge transfer capacitor that is not connected to the charge transfer transistor.

Specifically, in the negative step-up charge pump circuit of this embodiment, of all the step-up units in five stages, the one in the last stage, which remains excluded from the increasing and decreasing of the stage number, receives, as the voltage applied to its charge transfer capacitor C5, the variable terminal voltage S2, which is a pulse signal that changes its level either between the input voltage Vin and the ground voltage GND or between the stepped-up voltage 2Vin and the ground voltage GND. By contrast, the step-up units in the other stages receive, as the voltage applied to their charge transfer capacitors C1 to C4, one of the terminal voltage S1a and the inverted terminal voltage S1b, which both are pulse signals that change their level between the stepped-up voltage 2Vin and the ground voltage GND.

In the negative step-up charge pump circuit configured as described above, when a step-up factor of 10 (the maximal step-up factor) is specified, the step-up unit in all the stages are operated; in addition, to set the step-up input voltage in the last-stage step-up unit at 2Vin, it is fed with, as the voltage applied to its charge transfer capacitor C5, the variable terminal voltage S2, which is here a pulse signal that changes its level between the stepped-up voltage 2Vin and the ground voltage GND. When a step-up factor of 3 (the minimal step-up factor) is specified, only the step-up units in the fourth and last stages are operated; in addition, to set the step-up input voltage in the last-stage step-up unit at Vin, it is fed with, as the voltage applied to its charge transfer capacitor C5, the variable terminal voltage S2, which is here a pulse signal that changes its level between the input voltage Vin and the ground voltage GND. In similar manners, when a step-up factor of 4, 5, 6, 7, 8, or 9 is specified, the number of step-up units operated is increased or decreased and in addition the step-up input voltage in the last-stage step-up unit is varied to suit the specified step-up factor.

With this configuration, where the increasing and decreasing of the number of step-up units actually operated is combined with the varying of the step-up input voltage in one step-up unit, it is possible to change the step-up factor finely and in a wide range without unnecessarily increasing the number of step-up units needed, which has been impracticable with the conventional configuration, where the step-up units in all the stages receive an equal step-up input voltage.

So long as switching and charging/discharging similar to those described above can be achieved, many different configurations other than specifically described above may be adopted to produce the gate signals, to produce the first and second terminal voltages, and to realize the switches SW1a to SW4b.

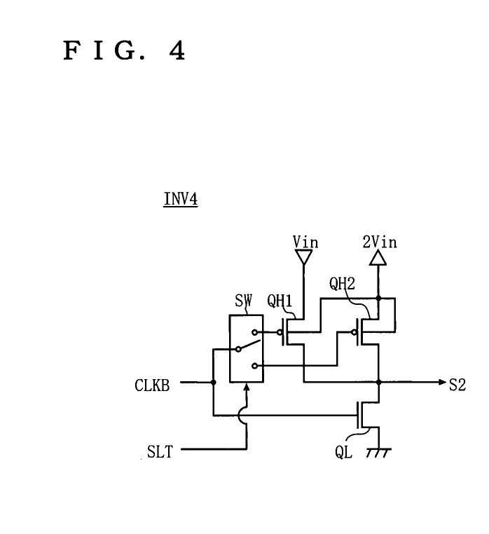

Next, with reference to FIG. 4, the circuit configuration of the inverter INV4 will be specifically described.

FIG. 4 is a circuit block diagram showing an example of the configuration of the inverter INV4.

As shown in FIG. 4, in this embodiment, the inverter INV4 includes P-channel field-effect transistors QH1 and QH2, an N-channel field-effect transistor QL, and a switch SW.

The common contact of the switch SW is connected to a point to which the inverted clock signal CLKB is applied. One output contact of the switch SW is connected to the gate of the transistor QH1, and the other output contact of the switch SW is connected to the gate of the transistor QH2. The control contact of the switch SW is connected to a point to which the step-up factor switching signal SLT is applied.

The source of the transistor QH1 is connected to a point to which the input voltage Vin is applied. The drain of the transistor QH1 is connected to a point from which the variable terminal voltage S2 is extracted. The backgate of the transistor QH1 is connected to a point to which the stepped-up voltage 2Vin is applied.

The source of the transistor QH2 is connected to a point to which the stepped-up voltage 2Vin is applied. The drain of the transistor QH2 is connected to a point from which the variable terminal voltage S2 is extracted. The backgate of the transistor QH2 is connected to a point to which the stepped-up voltage 2Vin is applied.

The drain of the transistor QL is connected to a point from which the variable terminal voltage S2 is extracted. The source of the transistor QL is grounded. The gate of the transistor QL is connected to a point to which the inverted clock signal CLKB is applied.

In the inverter INV4 configured as described above, when a step-up factor of 3, 5, 7, or 9 is specified by the step-up factor switching signal SLT, the switch SW changes the signal path of the inverted clock signal CLKB so that it is selectively fed to the gate of the transistor QH1. As a result of this switching, the variable terminal voltage S2 is now a pulse signal that changes its level between the input voltage Vin and the ground voltage GND.

By contrast, when a step-up factor of 4, 6, 8, or 10 is specified by the step-up factor switching signal SLT, the switch SW changes the signal path of the inverted clock signal CLKB so that it is selectively fed to the gate of the transistor QH2. As a result of this switching, the variable terminal voltage S2 is now a pulse signal that changes its level between the stepped-up voltage 2Vin and the ground voltage GND.

Thus, with the inverter INV4 of this embodiment, it is possible to vary, with a simple configuration, the step-up input voltage in one step-up unit according to the step-up factor specified.

Next, the basic operation (here, stepping-up by a factor of 10) of the negative step-up charge pump circuit configured as described above will be described.

First, consider the step-up unit in the first stage. When the clock signal CLK turns high, the gate signal G1a turns high, and the inverted gate signal G1b turns low. Thus, the transistor P1 turns ON, and the transistor P2a turns OFF. At this point, the terminal voltage S1a turns high, and the inverted terminal voltage S1b turns low. Thus, the ground voltage is applied to one end (the node a1) of the charge transfer capacitor C1, and the terminal voltage S1a, now high (2Vin), is applied to the other end (the node a2) of the charge transfer capacitor C1. Thus, the charge transfer capacitor C1, with a lower potential at the node al and a higher potential at the node a2, is charged until the potential difference across it becomes equal to the stepped-up voltage 2Vin.

After the charge transfer capacitor C1 is fully charged, when the clock signal CLK turns low, now the gate signal G1a turns low, and the inverted gate signal G1b turns high. Thus, the charge transfer transistor P1 turns OFF, and the transistor P2a turns ON. At this point, the terminal voltage S1a turns low, and the inverted terminal voltage S1b turns high. Thus, the potential at the node a2 falls from the stepped-up voltage 2Vin to the ground voltage GND. Here, since the charge transfer capacitor C1 has previously been charged so that now a potential difference approximately equal to the stepped-up voltage 2Vin is present across it, when the potential at the node a2 falls to the ground voltage GND, simultaneously the potential at the node al falls to −2Vin (=the ground voltage GND minus the charge voltage Vin).

Next, consider the step-up unit in the second stage. The potential (−2Vin) at the node a1 is applied via the transistor P2a to one end (the node b1) of the charge transfer capacitor C2, and the inverted terminal voltage S1b, now high (2Vin) is applied to the other end (the node b2) of the charge transfer capacitor C2. Thus, the charge transfer capacitor C2, with a lower potential at the node b1 and a higher potential at the node b2, is charged until the potential difference across it becomes equal to four times the input voltage Vin.

In the step-up units in the succeeding stages, switching and charging/discharging similar to those described above are repeated until eventually the electric charge stored in the charge transfer capacitor C5 in the last stage is transferred to the output capacitor Co. As a result, a negatively stepped-up voltage (−10Vin) ten times the input voltage Vin is obtained as the output voltage Vout.

In the negative step-up charge pump circuit of this embodiment, the last-stage charge transfer capacitor N5 and the output transistor No are built as N-channel field-effect transistors, which is ON when their gate voltage is high. This makes it possible to obtain sufficiently high gate-source voltages in later-stage transistors in their ON state without making them any larger and thereby to give them sufficiently high current driving performance, which is unachievable with the conventional configuration, where P-channel field-effect transistors are adopted in all the stages.

Moreover, in the negative step-up charge pump circuit of this embodiment, only the last-stage charge transfer capacitor N5 and the output transistor No are built as N-channel field-effect transistors. Thus, even when these N-channel field-effect transistors are formed by a process involving a single well alone, their source potential and backgate potential do not differ greatly, and this helps reduce the incidence of failure of the charge pump circuit at start-up resulting from the backgate effect, which is unachievable with the conventional configuration, where N-channel field-effect transistors are adopted in all the stages.

As described above, with the negative step-up charge pump circuit of this embodiment, it is possible to avoid start-up failure and poor current driving performance resulting from an increase in the number of stages of step-up units, without complicating the process or increasing the chip size.

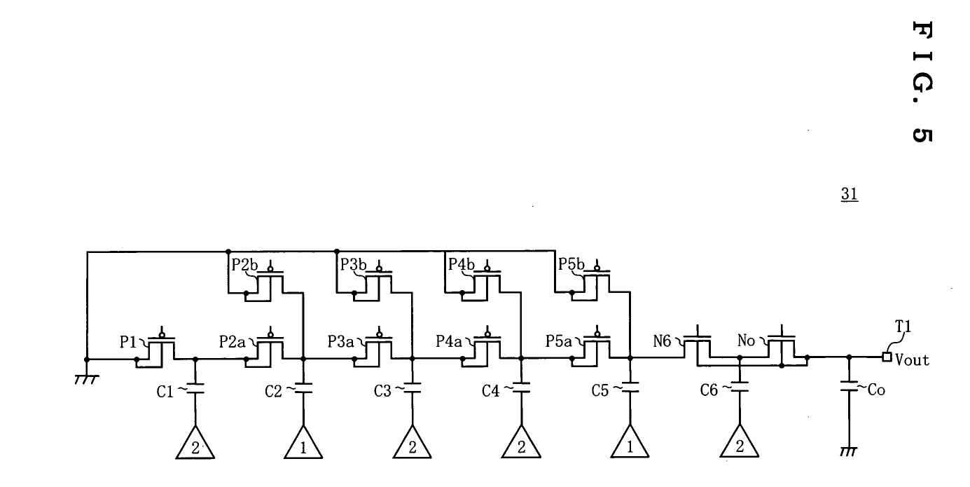

Next, as a second embodiment of the invention, another example of the negative step-up charge pump circuit included in the power supply circuit 31 will be described in detail below, with reference to FIG. 5.

FIG. 5 is a circuit block diagram of the power supply circuit 31 (and in particular the negative step-up charge pump circuit included in it) according to the second embodiment.

The negative step-up charge pump circuit of this embodiment, like that of the first embodiment described above, is configured as a charge pump circuit that negatively steps up an input voltage Vin to produce a desired output voltage Vout with a plurality of stages of step-up units built with charge transfer transistors and charge transfer capacitors, and includes a first controller (of which no part is illustrated here that is the same as in the first embodiment) for increasing and decreasing the number of stages of step-up units actually operated according to the step-up factor specified. The difference here is that there are provided, in a mixed fashion, at least one step-up unit (in the illustrated example, those in the second and fifth stages) that receives as a step-up input voltage a first step-up input voltage (the input voltage Vin) and at least one step-up unit (in the illustrated example, those in the first, third, fourth, and sixth stages) that receives as a step-up input voltage a second step-up input voltage (the stepped-up voltage 2Vin).

With this configuration, it is possible to allow free choice among irregular step-up factors (in this embodiment, step-up factors of 3, 5, 7, 8, and 10) without unnecessarily increasing the number of step-up stages, which is unachievable with the conventional configuration, where the step-up units in all the stages receive an equal step-up input voltage.

The embodiments described above deal with cases where the invention is applied to a power supply circuit (in particular a negative step-up charge pump circuit included in it) for a liquid crystal display device incorporated in a cellular phone terminal. This, however, is not meant to limit the application of the invention in any way; the invention finds wide application in charge pump circuits in general that step up an input voltage to produce a desired output voltage.

The invention may be practiced in any other manner than specifically described above, with any modification or variation made within the spirit of the invention.

For example, in the first embodiment described above, while a gate signal is being applied to one of the charge transfer transistors P2b, P3b, and P4b, the corresponding one of the charge transfer transistors P2a, P3a, and P4a connected in parallel with them respectively is kept OFF by the stepped-up voltage 2Vin applied to its gate. This, however, is not meant to limit in any way how the invention should be implemented; instead of the stepped-up voltage 2Vin, the output voltage Vout may be applied to the gate of that transistor to keep it ON. With this configuration, electric current can be supplied from ground via the charge transfer capacitor that is provided in the preceding stage and that is connected to the charge transfer transistor so kept ON. This helps improve the efficiency of the charge pump circuit.

The invention offers the following advantages: it helps realize charge pump circuits that can change their step-up factor finely and in a wide range without requiring an unnecessarily large number of step-up stages; hence, it helps realize LCD driver ICs and liquid crystal display devices incorporating such charge pump circuits.

In terms of industrial applicability, the invention is useful in varying the step-up factor of charge pump circuits finely and in a wide range without requiring an unnecessarily large number of step-up stages needed in them.

While the present invention has been described with respect to preferred embodiments, it will be apparent to those skilled in the art that the disclosed invention may be modified in numerous ways and may assume many embodiments other than those specifically set out and described above. Accordingly, it is intended by the appended claims to cover all modifications of the present invention which fall within the true spirit and scope of the invention.

What is claimed is:

1. A charge pump circuit comprising:
a plurality of stages of step-up units each comprising a charge transfer transistor and a charge transfer capacitor;
a first controller increasing and decreasing the number of step-up units actually operated according to a specified step-up factor; and
a second controller varying a step-up input voltage in at least one of the step-up units according to the specified step-up factor,
wherein the charge pump circuit produces a desired output voltage by stepping up an input voltage with said plurality of stages of step-up units.

2. The charge pump circuit of claim 1, wherein
said at least one of the step-up units receives, as a voltage applied to an end of the charge transfer capacitor that is not connected to the charge transfer transistor, a terminal voltage that is a pulse voltage whose level changes between the input voltage and a ground voltage or between a stepped-up voltage twice as high as the input voltage and the ground voltage, and
each of the other step-up units receives, as a voltage applied to an end of the charge transfer capacitor that is not connected to the charge transfer transistor, a terminal voltage that is a pulse voltage whose level changes between the stepped-up voltage and the ground voltage.

3. The charge pump circuit of claim 2,
wherein said at least one of the step-up units is the step-up unit in the last stage, and is excluded from the step-up units of which the number actually operated is increased and decreased.

4. An LCD driver IC comprising:
a charge pump circuit producing a drive voltage for a liquid crystal display panel,
wherein the charge pump circuit comprises:
a plurality of stages of step-up units each comprising a charge transfer transistor and a charge transfer capacitor;
a first controller increasing and decreasing the number of step-up units actually operated according to a specified step-up factor; and
a second controller varying a step-up input voltage in at least one of the step-up units according to the specified step-up factor,
wherein the charge pump circuit produces a desired output voltage by stepping up an input voltage with said plurality of stages of step-up units.

5. A liquid crystal display device comprising:
a liquid crystal display panel;
an LCD driver IC driving and controlling the liquid crystal display panel, wherein the LCD driver IC comprises:
a charge pump circuit producing a drive voltage for the liquid crystal display panel,
wherein the charge pump circuit comprises:
a plurality of stages of step-up units each comprising a charge transfer transistor and a charge transfer capacitor;
a first controller increasing and decreasing the number of step-up units actually operated according to a specified step-up factor; and
a second controller varying a step-up input voltage in at least one of the step-up units according to the specified step-up factor,
wherein the charge pump circuit produces a desired output voltage by stepping up an input voltage with said plurality of stages of step-up units.

6. A charge pump circuit comprising:
a plurality of stages of step-up units each comprising a charge transfer transistor and a charge transfer capacitor;
a controller increasing and decreasing the number of step-up units actually operated according to a specified step-up factor; and
wherein said plurality of stages of step-up units include, in a mixed fashion, step-up units receiving different step-up input voltages, and
wherein the charge pump circuit produces a desired output voltage by stepping up an input voltage with said plurality of stages of step-up units.

7. An LCD driver IC comprising:
a charge pump circuit producing a drive voltage for a liquid crystal display panel,
wherein the charge pump circuit comprises:
a plurality of stages of step-up units each comprising a charge transfer transistor and a charge transfer capacitor;
a controller increasing and decreasing the number of step-up units actually operated according to a specified step-up factor; and
wherein said plurality of stages of step-up units include, in a mixed fashion, step-up units receiving different step-up input voltages, and
wherein the charge pump circuit produces a desired output voltage by stepping up an input voltage with said plurality of stages of step-up units.

8. A liquid crystal display device comprising:
a liquid crystal display panel;
an LCD driver IC driving and controlling the liquid crystal display panel, wherein the LCD driver IC comprises:
a charge pump circuit producing a drive voltage for the liquid crystal display panel,
wherein the charge pump circuit comprises:
a plurality of stages of step-up units each comprising a charge transfer transistor and a charge transfer capacitor;
a controller increasing and decreasing the number of step-up units actually operated according to a specified step-up factor; and
wherein said plurality of stages of step-up units include, in a mixed fashion, step-up units receiving different step-up input voltages, and
wherein the charge pump circuit produces a desired output voltage by stepping up an input voltage with said plurality of stages of step-up units.
